(19) United States
(12) Patent Application Publication
(10) Pub. No.: US 2006/0064276 A1
(43) Pub. Date: Mar. 23, 2006

(54) Mobile phone with pedometer

(75) Inventors: Zhi-Hong Ren, Taipei (TW); Gui-Lin Wang, Taipei (TW); David Ho, Taipei (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: Inventec Appliances Corp.

(21) Appl. No.: 11/136,265

(22) Filed: May 23, 2005

(30) Foreign Application Priority Data
Sep. 23, 2004 (TW) 093128858

(51) Int. Cl. G01C 22/00; G06F 15/00

(52) U.S. Cl. 702/160

(57) ABSTRACT

A mobile phone with pedometer, which can detect the user's physical-activity status and can generate and display the calorie and fatness the user consumes via the user's inputting the related parameters, such as weight, stride, etc. is disclosed. Further, via inputting the parameters, such as the number of objective step, the standard of insufficient physical activity, etc., into the mobile phone with pedometer, the user can monitor and control his/her physical activity status.

### BACKGROUND OF THE INVENTION

1. Field of the Invention

The present invention relates to a mobile phone, particularly to a mobile phone with pedometer.

2. Description of the Related Art

With the progress of material civilization, nourishment and standard of living for people have been obviously promoted; however, owing to busy in daily life, physical activity, which is necessary for health, is usually insufficient for the people.

It is pointed out by related specialists that walking is the most suitable spot to the physical structure of the human being. Adequate amount of walking not only provides necessary physical activity but also incurs no sport injury. From the viewpoint of traditional Chinese medicine, walking can stimulate the acupoint of the foot sole, enhance the blood circulation, modulate the metabolism, keep the endocrine balance, and bring relaxation, so that health is improved and disease will be cured. Further, walking needs no specific place and instrument and thereby becomes one of mainstream sports of modern people.

The pedometer is born under the aforementioned trend. The pedometer is an instrument, which is carried by users to calculate the number of walking steps within a given interval of time. The users usually need to wear the conventional pedometer on left or right front side of their waist belt, and owing to its simple vibration-counting mechanism, the conventional pedometer has to keep perpendicular to the ground. In order to effectively monitor the physical-activity status, it is a corollary for users to wear the pedometer every day.

Therefore, if the pedometer is integrated with the mobile phone to provide a mobile phone having the function of pedometer, not only the physical activity of walking is enabled to be more convenient but also the users can be free from additionally wearing a separate pedometer; thus, the resource of mobile phone is further exploited, and the utility of mobile phone is further increased.

### SUMMARY OF THE INVENTION

In the aforementioned problems of the prior art, the primary objective of this invention is to provide a mobile phone with pedometer, wherein a user can monitor his/her physical-activity status just via the mobile phone with pedometer and without any additional instrument.

To achieve the objective mentioned above, the mobile phone with pedometer of this invention utilizes a pedometer module to transform the displacement of the user in vertical direction into a signal level, which is further transmitted to a calculation module. The calculation module utilizes the change of slope in the received signal levels to generate related physical-activity data, such as walking steps, effective steps, entire walking distance, time of effective physical-activity, calorie consumption, fatness consumption, etc., which are further sent to a storage module and a display module respectively.

The control module can input various parameters and control instructions, such as the number of objective step, the parameter of insufficient physical activity, the height of the user, the stride of the user, etc., to the storage and calculation module to enable the user to be able to effectively monitor and control his/her own physical-activity status.

To enable the objective, characteristics, and function of the present invention to be further understood, the present invention will be described below in detail in cooperation with the attached drawings.

### BRIEF DESCRIPTION OF THE DRAWINGS

FIG. 1 shows the circuitry block diagram of the mobile phone with pedometer of present invention.

### DETAILED DESCRIPTION OF THE INVENTION

The present invention is to integrate the pedometer with the mobile phone to enable users to have the related information of pedometer without additionally carrying a separate pedometer.

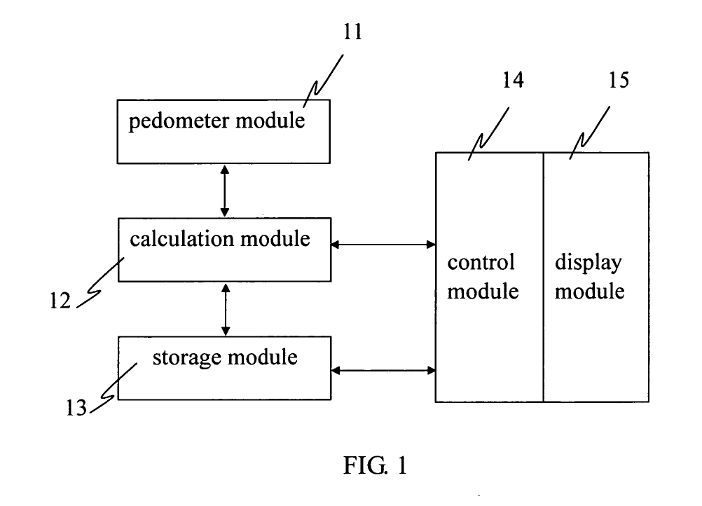

Refer to FIG. 1 the circuitry block diagram of the present invention's mobile phone with pedometer. The mobile phone with pedometer of this invention comprises a pedometer module 11, a calculation module 12, a storage module 13, a control module 14, and a display module 15.

The pedometer module 11 is an acceleration sensor, which transforms a displacement change of the user in vertical direction into a signal level. The signal level is then processed with a low-pass filter, sampled, de-noised, and then output.

In a preferred embodiment of the present invention, the pedometer module is a MEMSIC accelerometer, which utilizes the principle of thermodynamics to detect velocity change, and whose characteristics is to utilize a heated air bubble inside a silicon substrate to measure acceleration, wherein the silicon substrate is etched to form a small chamber and an electric-resistance heater is disposed at the center of the chamber and thermocouples are disposed on both sides of the chamber. When there is no acceleration, the hot air in the heater is in equal distance to the thermocouples on both sides. When there is acceleration, the hot air will flow toward one of the thermocouples, and the temperature change will be sensed by the related electronic device and transformed into the presently detected acceleration to output. However, it is to be noted that the MEMSIC accelerometer is only a preferred embodiment, and that the pedometer module can also adopt other instruments having the function of pedometer.

The calculation module 12 is a central processing unit (CPU) of the mobile phone, which is coupled to the pedometer module 11 to receive, analyze and calculate the signal level output by the pedometer module 11. The related physical-activity data, such as walking steps, effective steps, entire walking distance, time of effective physical activity, calorie consumption, fatness consumption, etc., can be worked out via the detected slope change of the signal levels.

The storage module 13 is the flash memory of the mobile phone, which is coupled to the calculation module 12 to receive and store the physical-activity data generated by the calculation module 12.

The control module 14 is coupled to the calculation module 12 and the storage module 13 respectively. The user can utilize the control module 14 to input parameters or related control instructions.

The display module 15 is coupled to the calculation module 12 and the storage module 13 and displays the physical-activity data of the user.

After the user of the mobile phone with pedometer initiates the function of the pedometer via the control module 14, the pedometer module 11 begins to detect the physical activity of the user. The displacement change of the user in vertical direction will be transformed into a signal level, which will be sent to the calculation module 12 after being processed with a low-pass filter, sampled and de-noised. The calculation module 12 works out the walking steps and the effective steps of the user according to the detected slope change of the signal levels. (In contrast to a random walking in general activity, the effective steps herein refers to the steps accumulated in an effective physical sport, for example, the steps accumulated in the state that the user might walk continuously for at least ten minutes at the speed of at least sixty steps per minute.) The calculation module 12 will also send the physical-activity data to the storage module 13 and output the physical-activity to the display module 15.

Further, the user can utilize the control module 14 to input parameters, such as the weight of the user, the stride of the user, etc., to the storage module 13. (Herein, the stride is the averaged span of each step, for example, the accumulated distance of ten steps divided by ten.) According to the physical-activity status detected by the pedometer module 11 and the parameters of weight and stride stored in the storage module 13, the calculation module 12 can generate the calorie and fattiness consumed by the user, which is further output to the display module 15 for display.

The user can also utilize the control module 14 to input the parameter of objective step to the storage module 13. When the user does not achieve the objective step within a given interval of time (for example, one day), the mobile phone will alert the user via the display module 15. Once the user has achieved the set objective step, the mobile phone will inform the user via the signal sent out by the display module 15. For example, when the user does not achieve the objective step within a given interval of time, the display module 15 displays related animation on the display screen and sends out music or ring tone to alarm the user, and once the user has achieved the set objective step, the display module 15 also displays related animation and sends out music or ring tone for encouraging the user.

Besides, the user can also utilize the control module 14 to input the parameter of insufficient physical activity to the storage module 13. When the user does not achieve the preset amount of physical activity within a given interval of time, the display module 15 will send out an alarm to alert the user.

Furthermore, in order to increase the fun of physical activity, the mobile phone with pedometer of this invention can utilize the calculation module 12 to control the display module 15 to emit a flickering flash mated with the user's steps once the pedometer module 11 detects the user's march.

Moreover, in addition to setting various kinds of parameters, the control module 14 can also send control instructions to the storage module 13 and the calculation module 12. For example, the control module 14 can send on/off signal to the calculation module 12 to control the on/off of the pedometer function, and the control module 14 can also send a signal to the storage module 13 to check the related physical-activity data or even to send the user's physical-activity records to his/her doctor or the related personnel via a SMS (Short Message Service) message.

The preferred embodiments mentioned above are only to disclose the present invention, and not intended to limit the scope of the present invention. Any equivalent modification or variation made by the person skilled in the art according to the spirit or claims of the present invention will be included within the scope of the present invention. The scope of the present invention is to be dependent upon the claims appended to the present specification.

What is claimed is:

1. A mobile phone with pedometer, comprising:
a pedometer module detecting a user's physical-activity status;
a calculation module, coupled to said pedometer module and generating physical-activity data of the user according to the physical-activity status, detected by said pedometer module;
a storage module coupled to said calculation module receiving, and storing the physical-activity data generated by said calculation module;
a control module coupled to said calculation module and said storage module respectively and inputting parameters or control instructions to said calculation module and said storage module; and
a display module coupled to said calculation module and said storage module respectively, and displaying the physical-activity data of the user.

2. The mobile phone with pedometer as claimed in claim 1, wherein said pedometer module transforms a displacement change of said user in vertical direction into a signal level and outputs said signal level to said calculation module detecting a slope change of a series of said signal levels to generate the physical-activity data of said user.

3. The mobile phone with pedometer as claimed in claim 1, wherein said calculation module is a central processing unit (CPU) of said mobile phone.

4. The mobile phone with pedometer as claimed in claim 1, wherein said storage module is a flash memory of said mobile phone.

5. The mobile phone with pedometer as claimed in claim 1, wherein said physical-activity data includes the number of the user's walking steps.

6. The mobile phone with pedometer as claimed in claim 1, wherein said physical-activity data includes the number of effective walking steps.

7. The mobile phone with pedometer as claimed in claim 1, wherein said physical-activity data includes the calorie consumption of said user.

8. The mobile phone with pedometer as claimed in claim 1, wherein said physical-activity data includes the fatness consumption of said user.

9. The mobile phone with pedometer as claimed in claim 1, wherein said parameters input by said control module include the weight of said user.

10. The mobile phone with pedometer as claimed in claim 1, wherein said parameters input by said control module include the stride of said user.

11. The mobile phone with pedometer as claimed in claim 1, wherein said parameters input by said control module include an objective step of said user.

12. The mobile phone with pedometer as claimed in claim 11, wherein if said user does not achieve said objective step within a given interval of time, said display module sends out an alarm, and if said user has achieved said objective step within a given interval of time, said display module sends out a notice.

13. The mobile phone with pedometer as claimed in claim 1, wherein said parameters input by said control module include the parameter of insufficient physical activity of said user.

14. The mobile phone with pedometer as claimed in claim 13, wherein if said user does not achieve the amount of physical activity set by said parameter of insufficient physical activity within a given interval of time, said display module send out an alarm, and if said user has achieved the amount of physical activity set by said parameter of insufficient physical activity within a given interval of time, said display module send out a notice.

15. The mobile phone with pedometer as claimed in claim 1, wherein said physical-activity data stored in said storage module can be sent out via a SMS (Short Message Service) message.

16. The mobile phone with pedometer as claimed in claim 1, wherein said display module can emit a flickering flash mated with said user's march.
